(19) United States
(12) Patent Application Publication
(10) Pub. No.: US 2017/0170674 A1
(43) Pub. Date: Jun. 15, 2017

(54) METHODS FOR TRAPPING ELECTRONS AT AN INTERFACE OF INSULATORS EACH HAVING AN ARBITRARY THICKNESS AND DEVICES THEREOF

(71) Applicant: Nth Tech Corporation, Churchville, NY (US)

(72) Inventor: Michael D. Potter, Churchville, NY (US)

(21) Appl. No.: 15/372,852

(22) Filed: Dec. 8, 2016

Related U.S. Application Data
(60) Provisional application No. 62/265,269, filed on Dec. 9, 2015.

(51) Int. Cl. H02J 7/00; H01G 4/005; H01G 4/33; H01G 4/10

(52) U.S. Cl. CPC H02J 7/0052; H01G 4/10; H01G 4/005; H01G 4/33

(57) ABSTRACT

A method for trapping electrons includes providing an insulator structure comprising at least two insulator layers. Two or more spaced apart electrical contacts to an interface between the at least two insulator layers are formed. An electrical bias is formed for a period of time across the two or more spaced apart electrical contacts in the insulator structure to fill electron traps at the interface between the at least two insulator layers.

This application claims the benefit of U.S. Provisional Patent Application Ser. No. 62/265,269, filed Dec. 9, 2015, which is hereby incorporated by reference in its entirety.

### FIELD

This technology relates to methods for trapping electrons at an interface of insulators each having an arbitrary thickness and devices thereof.

### BACKGROUND

A large number of electrons can be stored at the interface of two dissimilar insulators. For example, up to and even greater than 1×10¹³ electrons per square centimeter can be stored at the interface of two dissimilar insulators. For many applications, such as for electronic data storage devices, one of the two dissimilar insulators is very thin, for example having a thickness on the order of 1 to 2 nanometers.

What is less well known is that dissimilar insulators which are much thicker than the dissimilar insulators described above may also be utilized to store a high density of electrons at the interface. In these examples, each of these dissimilar insulators can be several hundred nanometers thick and high electrical fields can be used to inject the electrons that subsequently become trapped at the interface between the dissimilar insulators.

A particular example where an electron embedded charge layer with thicker dissimilar insulators is very useful is the intensification of an electric field within the active region of a photovoltaic device, such as a solar cell. Significantly increasing the active layer electrical field helps insure exciton decoupling, longer carrier lifetimes, reduced random electron-hole recombination, and overall greater efficiency.

Unfortunately, when the thickness of each of the dissimilar insulators goes beyond several hundred nanometers, such as at least 1000 nanometers thick, which can be desirable in some applications, then high electric field injection becomes impractical. Therefore for these thicker dissimilar insulators ballistic electron injection is necessary. However, ballistic electron injection can alter the morphology of the structure in undesirable ways. Accordingly, with prior existing technologies the only way to inject and trap electrons at a dissimilar insulator interface with relatively thick individual layers, for example beyond several hundred nanometers, is by ballistic electron injection with the resulting and undesired altered morphological insulator structure.

### SUMMARY

A method for trapping electrons includes providing an insulator structure comprising at least two insulator layers. Two or more spaced apart electrical contacts to an interface between the at least two insulator layers are formed. An electrical bias is formed for a period of time across the two or more spaced apart electrical contacts in the insulator structure to fill electron traps at the interface between the at least two insulator layers.

This technology provides a number of advantages including providing a new unique alternative for electron injection and trapping at the interface of insulator layers of arbitrary thicknesses. With this technology, electron injection via high energy ballistic processes which can undesirably alter the morphology of the dissimilar insulator layers is not required.

The examples of this technology as illustrated and described herein significantly enhance and simplify the process of storing a high density of electrons for applications, such as but not limited to, xenon ion accelerator grids for ion thruster engines. Additionally, this technology significantly increases the internal electric field to enhance exciton decoupling, provide longer electron and hole carrier lifetimes, reduce unwanted random electron-hole recombination, and increase the probability of singlet fission in photovoltaic devices.

### BRIEF DESCRIPTION OF THE DRAWINGS

FIGS. 1-4 are cross-sectional diagrams of an example of a method for electron injection and trapping at an interface of dissimilar insulator layers each having an arbitrary thickness;

FIG. 5 is a cross-sectional diagram of another example of dissimilar insulator layers each having an arbitrary thickness with electrons trapped at one or more interfaces using another example of this method;

FIG. 6 is a cross-sectional diagram of another example of insulator layers each having an arbitrary thickness with electrons trapped at one or more interfaces using another example of this method; and

FIG. 7 is a cross-sectional diagram of another example of insulator layers each having an arbitrary thickness with electrons trapped at one or more interfaces using yet another example of this method.

### DETAILED DESCRIPTION

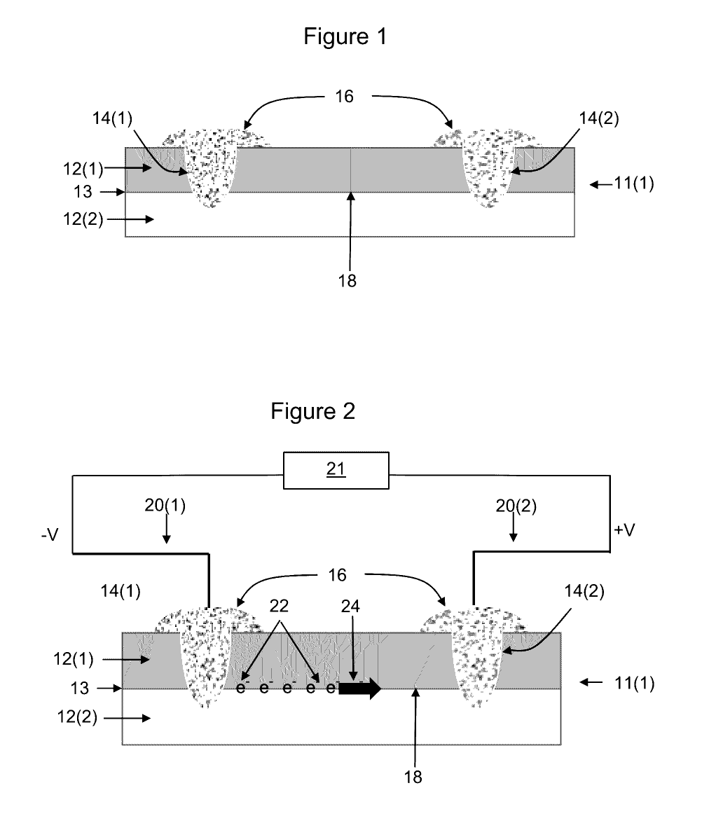

An example of a method for electron injection and trapping at an interface of dissimilar insulator layers each having an arbitrary thickness is illustrated in FIGS. 1-4, although the method could include other types and/or numbers of steps in other orders. This technology provides a number of advantages including providing a new unique alternative for electron injection and trapping at the interface of insulator layers of arbitrary thicknesses.

Referring more specifically to FIGS. 1-4, the example of the method for trapping electrons at interface of dissimilar insulator layers each having an arbitrary thickness will now be described, although the method can be used with other types and/or numbers of similar and/or dissimilar insulator layers. By way of example only, examples of this technology are advantageous for insulating layers each having a thickness of at least 1000 nanometers.

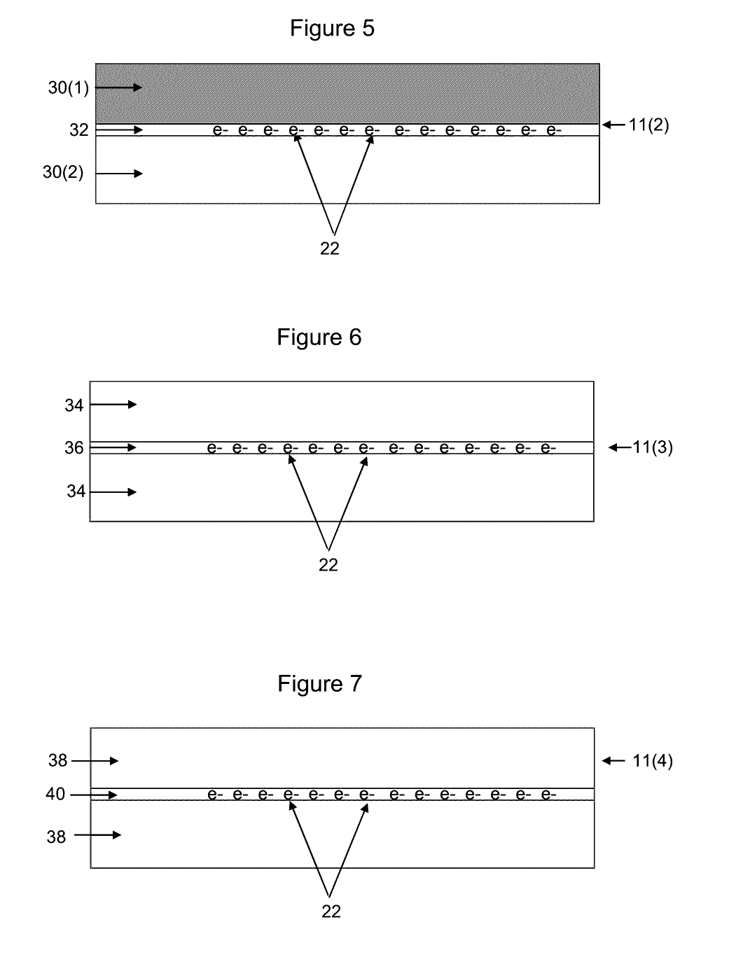

Referring to FIG. 1, a dual insulator structure 11(1) with two dissimilar insulator layers 12(1) and 12(2) is provided, although other types of structures with other types and/or numbers of layers in other configurations can be used. By way of further example only, the insulator structure may have at least two dissimilar stoichiometric insulator layers separated by a non-stoichiometric insulator layer, at least two matching stoichiometric insulator layers separated by a non-stoichiometric insulator layer, or at least two stoichiometric insulator layers separated by at least one non-stoichiometric insulator layer made of the same material, such as the examples of insulator structures 11(2)-11(4) shown in FIGS. 5-7.

Next, two or more spaced apart openings 14(1) and 14(2) are formed in the dual insulator structure 11(1) that extend at least to the dissimilar insulator interface 13 and in this example partially beyond as illustrated, although other numbers and/or types of openings or other passages of other depths may be used. Each of the openings 14(1) and 14(2) has a minimum overall dimension to be able to receive a conductor that can conduct the applied electrical bias for electron injection and trapping at the interface 13 of insulator layers 12(1) and 12(2).

Next, a conductor 16, such as a metal or metals by way of example only, is deposited into each of the spaced apart openings 14(1) and 14(2) to form electrical contacts, although other types and/or numbers of different types of conducting material or materials could be used.

Referring to FIG. 2, next conducting electrodes 20(1) and 20(2) are each coupled to one of the conductors 16 in each of the spaced apart openings 14(1) and 14(2), respectively, to establish an electrical connection, although other manners for connecting the power source to apply the electrical bias can be used. Once the conducting electrodes 20(1) and 20(2) are coupled to the spaced apart conductors 16, the power source 21 may be activated to apply a direct current (DC) bias for a period of time so that electrons 22 begin to traverse the interface 13 as illustrated in FIG. 2, although other types of devices that may provide the electrical bias, such as an alternating current (AC) bias by way of example only, may be used. By way of example only, the period of time may be no more than about five seconds.

Since there is a high density of electron traps, typically at energies well below the conduction band minimum of one or more of the insulator layers 12(1) and 12(2), initial electrons will tend to fill those electron traps. When a given electron trap has captured and immobilized an electron, additional electrons will pass beyond the trapped electron and either become trapped in an unoccupied electron trap 24 or become a conduction electron. In this manner with the DC bias applied via the conducting electrodes 20(1) and 20(2) to the spaced apart conductors 16 all allowable electron traps at the interface 13 can be filled, although again other types of electrical bias could be applied, such as an AC bias by way of example only. Therefore a high density of electrons can be stored at the interface 13 of the dissimilar insulator layers 12(1) and 12(2) in this example, without the prior art limitations discussed in the background, such as restrictions on the thickness of the insulator layers or any damage from high energy ballistic injected electrons. Since there are a large number of interface states at the interface 13 of the dissimilar insulator layers 12(1) and 12(2), the dual insulator structure 11(1) becomes a morphological insulator with high bulk insulating properties together with a two dimensional orthogonal virtual conducting and charge trapping layer 18 at the interface 13.

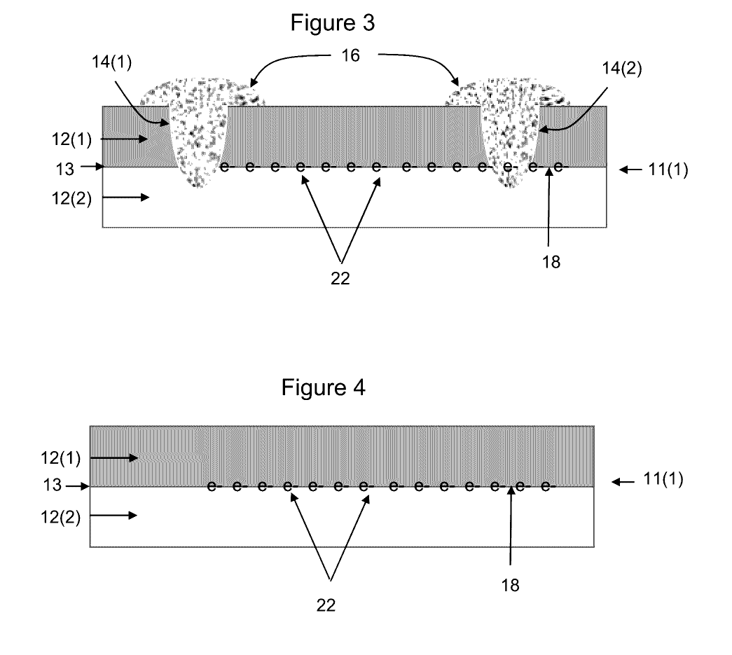

Referring to FIG. 3, when the electron traps at the interface 13 are filled, the conducting electrodes 20(1) and 20(2) from the power source 21 may be disconnected from the conductor 16 in each of the spaced apart openings 14(1) and 14(2), respectively, although the electrodes could be disconnected at other times, such as at only a partial filling of the electron traps at the interface 13 by way of example only.

Referring to FIG. 4, next the conductor 16 in each of the spaced apart openings 14(1) and 14(2) may be removed and the spaced apart openings 14(1) and 14(2) may filled with a suitable material, such as a material or materials which match or otherwise correspond with each of the dissimilar insulator layers 12(1) and 12(2) by way of example only.

Referring to FIG. 5, another example of a method for trapping electrons at one or more interfaces of dissimilar insulator layers each having an arbitrary thickness will now be described. This example of the method is the same as the one illustrated and described with reference to FIGS. 1-4, except as illustrated and described herein.

In this particular example shown in FIG. 5, an insulator structure 11(2) is provided with a first stoichiometric insulator layer 30(1), a non-stoichiometric insulator layer 32 and a second stoichiometric insulator layer 30(2) which is different from the first stoichiometric insulator layer 30(1), although the structure may have other types and/or numbers of layers in other configurations. The first stoichiometric insulator layer 30(1) and the second stoichiometric insulator layer 30(2) comprise dissimilar materials, such as SiO₂ or Si₃N₄ by way of example only, although other types and/or numbers of materials may be used for each. The non-stoichiometric insulator layer 32 may comprise non-stoichiometric silicon oxide (SiO₂₋ₓ), non-stoichiometric silicon nitride (Si₃N_{4-y}), or non-stoichiometric aluminum oxide (Al₂O_{3-z}), although other types and/or numbers of materials may be used for this layer. At least a region of the at least one non-stoichiometric insulator layer 32 may be doped to further enhance trapping of electrons. With this example illustrated in FIG. 5, a substantially greater number of allowable energy levels can be created than with the example shown with reference to FIGS. 1-4.

In this example shown in FIG. 5, the holes 14(1) and 14(2) are formed so that the conductors 16 formed in the holes 14(1)-14(2) extend at least to the at least one non-stoichiometric insulator layer 32, although as with FIGS. 1-4 the conductors 16 could be formed to extend to other depths past the at least one non-stoichiometric insulator layer 32.

Next, electrical connections 20(1)-20(2) from the power source 21 are coupled to the conductors 16 which extend to at least the at least one non-stoichiometric insulator layer 32 in the insulator structure 11(2). Next, a DC bias from power source 21 may be applied so that electrons 22 begin to traverse and are trapped in the non-stoichiometric insulator layer 32, although other types and/or number of non-stoichiometric insulator layer or layers may be used to trap electrons and again other types of electrical bias can be applied, such as an AC bias by way of example only.

Referring to FIG. 6 another example of a method for trapping electrons at one or more interfaces of insulator layers each having an arbitrary thickness will now be described. This example of the method is the same as the one illustrated and described with reference to FIGS. 1-4, except as illustrated and described herein.

In this particular example shown in FIG. 6, an insulator structure 11(3) is provided that utilizes a single basic insulator material arranged in layers as a stoichiometric layer 34, a non-stoichiometric 36 layer, and a stoichiometric 34 layer. By way of example only, the single basic insulator material for the stoichiometric layer 34, the non-stoichiometric 36 layer, and the stoichiometric 34 layer may comprise: SiO₂/SiO₂₋ₓ/SiO₂; Al₂O₃/Al₂O_{3-z}/Al₂O₃; or Si₃N₄/Si₃N_{4-y}/Si₃N₄, although other types and/or numbers of other materials in other arrangements could be used. At least a region of the at least one non-stoichiometric insulator layer 36 may be doped to further enhance trapping of electrons.

In this example shown in FIG. 6, the holes 14(1) and 14(2) are formed so that the conductors 16 formed in the holes 14(1)-14(2) extend at least to the at least one non-stoichiometric insulator layer 36, although as with FIGS. 1-4 the conductors 16 could be formed to extend to other depths past the at least one non-stoichiometric insulator layer 36.

Next, electrical connections 20(1)-20(2) from the power source 21 are coupled to the conductors 16 which extend to at least the at least one non-stoichiometric insulator layer 36 in the insulator structure 11(3). Next, a DC bias from power source 21 may be applied so that electrons 22 begin to traverse and are trapped in the at least one non-stoichiometric insulator layer 36, although other types and/or number of non-stoichiometric insulator layer or layers may be used to trap electrons and again other types of electrical bias can be applied, such as an AC bias by way of example only.

Referring to FIG. 7 another example of a method for trapping electrons at one or more interfaces of insulator layers each having an arbitrary thickness will now be described. This example of the method is the same as the one illustrated and described with reference to FIGS. 1-4, except as illustrated and described herein.

In this particular example, an insulator structure 11(4) is provided that utilizes a single basic insulator material arranged in layers as a stoichiometric layer 38, a non-stoichiometric layer 40 which has a doped region, such as doping the layer 40 with lead (Pb) to enhance trapping of electrons by way of example only, and another stoichiometric 38 layer, although the structure could have other types and/or numbers of other layers. By way of example only, the stoichiometric layer 38, the non-stoichiometric layer 40, and the stoichiometric 38 layer may comprise layers of SiO₂/SiO₂:Pb/SiO₂, although other types and/or numbers of other materials with other doped regions in other arrangements could be used for each of the layers.

In this example shown in FIG. 7, the holes 14(1) and 14(2) are formed so that the conductors 16 formed in the holes 14(1)-14(2) extend at least to the at least one non-stoichiometric layer 40, although as with FIGS. 1-4 the conductors 16 could be formed to extend to other depths past the at least one non-stoichiometric layer 40.

Next, electrical connections 20(1)-20(2) from the power source 21 are coupled to the conductors 16 which extend to at least the at least one non-stoichiometric layer 40 in the insulator structure 11(2). Next, a DC bias from power source 21 may be applied so that electrons 22 begin to traverse and are trapped in the at least one non-stoichiometric layer 40, although other types and/or number of non-stoichiometric insulator layer or layers may be used to trap electrons and again other types of electrical bias can be applied, such as an AC bias by way of example only.

Accordingly, as illustrated and described by way of reference to the examples herein, this technology will significantly enhance and simplify the process of storing a high density of electrons for applications, such as, but not limited to, xenon ion accelerator grids for ion thruster engines. Additionally, this technology significantly increases the internal electric field to enhance exciton decoupling, provide longer electron and hole carrier lifetimes, reduce unwanted random electron-hole recombination, and increase the probability of singlet fission in photovoltaic devices.

Having thus described the basic concept of this technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of this technology. Additionally, the recited order of processing elements or sequences, or the use of numbers, letters, or other designations therefore, is not intended to limit the claimed processes to any order except as may be specified in the claims. Accordingly, this technology is limited only by the following claims and equivalents thereto.

What is claimed is:

1. A method for trapping electrons, the method comprising:
providing an insulator structure comprising at least two insulator layers;
forming two or more spaced apart electrical contacts to an interface between the at least two insulator layers; and
applying an electrical bias for a period of time across the two or more spaced apart electrical contacts in the insulator structure to fill electron traps at the interface between the at least two insulator layers.

2. The method as set forth in claim 1 wherein the forming the two or more spaced apart electrical contacts further comprises:
forming at least two spaced apart openings in the insulator structure that each extend to at least an interface between the at least two insulator layers;
depositing a conductor into each of the spaced apart openings in the insulator structure.

3. The method as set forth in claim 2 further comprising at least partially removing the conductor from each of the spaced apart openings in the insulator structure after the applying of the electrical bias.

4. The method as set forth in claim 3 further comprising at least partially filling at least one of the spaced apart openings with an insulating material after the at least partially removal of the conductor.

5. The method as set forth in claim 1 wherein the providing the insulator structure further comprises providing the insulator structure comprising at least two dissimilar stoichiometric insulator layers separated by a non-stoichiometric insulator layer.

6. The method as set forth in claim 5 wherein the non-stoichiometric insulator layer comprises a layer of non-stoichiometric silicon oxide (SiO₂₋ₓ,), a layer of non-stoichiometric silicon nitride (Si₃N_{4-y}), or a layer of non-stoichiometric aluminum oxide (Al₂O_{3-z}).

7. The method as set forth in claim 1 wherein the providing the insulator structure further comprises providing the insulator structure comprising at least two stoichiometric insulator layers separated by at least one non-stoichiometric insulator layer made of the same material.

8. The method as set forth in claim 7 wherein the at least two stoichiometric insulator layers separated by the non-stoichiometric insulator layer comprise at least one of: SiO₂/SiO₂₋ₓ/SiO₂; Al₂O₃/Al₂O_{3-z}/Al₂O₃; or Si₃N₄/Si₃N_{4-y}/Si₃N₄.

9. The method as set forth in claim 1 wherein the providing the insulator structure further comprises providing the insulator structure comprising at least two matching stoichiometric insulator layers separated by a non-stoichiometric insulator layer.

10. The method as set forth in claim 9 further comprising doping at least a region of the at least one non-stoichiometric insulator layer.

11. The method as set forth in claim 9 wherein the at least two matching stoichiometric insulator layers separated by the non-stoichiometric insulator layer comprise SiO₂/SiO₂:Pb/SiO₂.

12. The method as set forth in claim 1 wherein each of the at least two insulator layers have an overall thickness greater than at least 1000 nm

13. The method as set forth in claim 1 wherein the period of time is no more than five seconds.
